(19) United States
(12) Patent Application Publication
(10) Pub. No.: US 2009/0320652 A1
(43) Pub. Date: Dec. 31, 2009

(54) SOCKET FOR ELECTRICAL CONDUIT LOCKNUTS

(76) Inventors: Douglas R. Allred, Heber, UT (US); Shawn J. Sweat, Heber, UT (US)

Correspondence Address: ANGUS C. FOX, III, 4093 N. IMPERIAL WAY, PROVO, UT, 84604-5386, US

(21) Appl. No.: 12/486,742

(22) Filed: Jun. 17, 2009

Related U.S. Application Data
(60) Provisional application No. 61/073,363, filed on Jun. 17, 2008.

(51) Int. Cl. B25B 13/50; B25B 13/06

(52) U.S. Cl. 81/176.2; 81/124.6

(57) ABSTRACT

The present invention provides a socket wrench for electrical locknuts that is highly tolerant of size differences of electrical locknuts of a nominal size and the number and spacing of lugs thereon. The socket wrench, in its most simple form, is machined from a single piece of metal, and includes a cylindrical wall that is unitary with a socket ceiling having a square drive aperture centered therein. A pair of diametrically-opposed semi-cylindrical vertical projections extend inwardly from the cylindrical wall. The vertical projections operate on a pair of diametrically-opposed lugs on the electrical locknut. The semi-cylindrical shape of the vertical projections causes the socket to self-center on an engaged locknut when the socket is turned in either clockwise or counterclockwise direction.

This application has a priority date based on the filing of provisional patent application 61/073,363, which was filed on Jun. 17, 2008.

### FIELD OF THE INVENTION

The present invention generally relates to sockets and, more specifically, to sockets for use with electrical conduit locknuts.

### BACKGROUND OF THE INVENTION

Electro-metallic tubing, or EMT as it is commonly known, is thin-walled steel conduit that is commonly employed to encase conductors for electric circuits. EMT ranges in diameter from ½-inch to 4 inches. In order to secure the ends of EMT runs to switch, outlet, and connection boxes, a threaded male stub end fitting is slipped over and secured to the end of the tubing with either one or more set screws or a threaded compression nut. The threaded male stub end is then inserted through a knock-out in the switch, outlet or connection box, and subsequently secured to the box with a locknut having a plurality of peripheral tightening lugs. During assembly or disassembly of the conduit structure, the locknuts are respectively tightened and loosened by an electrician. For considerably more than half a century, the tool of choice for tightening these locknuts has been a flat bladed screwdriver. Electricians have typically tightened or loosened such locknuts by placing the tip of a flat bladed screwdriver against a lug of the locknut and striking the handle of the screwdriver with a hammer to manipulate the locknut about threads of a conduit end opening. This method of manipulating a locknut has several problems. First, it is difficult to estimate the torque being applied to the locknut, which may result either in it not being adequately tightened, or over-tightened so that the threads on the locknut and/or the threaded male stud end are stripped. Secondly, the use of a screwdriver as a punch is ill-advised, as the worker may injure himself or damage equipment if the screwdriver slips off the lug of the locknut.

U.S. Pat. No. 3,768,345 to James E. Barnes discloses a spanner type square-drive head for use with serrated locknuts used in electrical connector boxes, the drive head having teeth for engaging the lugs of the locknut and also having an aperture or mouth to accommodate electrical cable in the connector box.

U.S. Pat. No. 4,836, 065 to Tyrus W. Setliff discloses a socket having a T-bar handle for removing a radiator cap. The socket has a pair of opposed notches which engage the ears of a radiator cap. A pressure relief valve engagement member, which depresses the pressure relief valve of a radiator cap, may be disposed within the socket.

U.S. Pat. No. D329,788 to Peter Andrew discloses a combination box-end/open-end wrench for locknuts. Both ends of the wrench have equiangually-spaced notches which engage the lugs of a locknut.

U.S. Pat. No. 5,524,511 to Michael Takas discloses a wrench for engaging and rotating locknuts. The wrench has a generally C-shaped head pivotally attached by an extension member to a handle. A recessed step extends par way around an interior arc of the head, and has a radius sufficient to receive the overall diameter of a locknut. The recessed step is terminated by a shoulder at the end of each arcuate arm forming the head. The shoulders extend toward the center of the head and have dimensions and spacing to fit into the spaces between lugs on a locknut. When the wrench is placed over a locknut, the shoulders fit between and engage lugs on the locknut so that the latter can be turned clockwise or counterclockwise.

U.S. Pat. No. D379,053 to James B. Howard discloses a locknut wrench having a head at both ends of a handle, each head having with arcuate arms, with each arm being equipped with a pair of downwardly projecting crenellations which are sized and spaced to engage the lugs of a locknut so that the latter may be turned about its rotational axis. Each head of the wrench may be sized for locknuts of different dimensions.

U.S. Pat. No. 6,058,813 to Paul Bryant and Barry D. Luthanen discloses a locknut socket wrench having a socket pivotally coupled to a breaker bar handle. The socket has a cylindrical wall with two opposing pairs of downwardly projecting crenellations, which are sized and spaced to engage the lugs of a locknut so that the latter may be turned about its rotational axis. The lug engagement crenellations are similar to those of the Howard locknut wrench described above. The cylindrical wall of the socket has at least one cutout which serves as a wire/cable port.

U.S. Pat. No. D461,107 to Edmond Lee Pitt discloses a combination box-end/open-end wrench for lugged fasteners or locknuts. Equiangularly-spaced notches are provided in both ends of the wrench for the engagement of fastener lugs.

U.S. Pat. No. D529,349 to Edward F. Kitchen and Bradley D. Kitchen discloses a spanner wrench for electrical conduit fitting locknuts having a handle rigidly coupled to a had having a pair of arcuate arms, each of which ends in an inwardly facing projection. The pair of inwardly facing projections engage gaps between lugs on opposite sides of a locknut, thereby enabling rotation of the locknut in both clockwise and counterclockwise directions.

U.S. Pat. No. 6,826,984 to Keith K. Poppen discloses a socket for manipulating a conduit locknut comprises a wall enclosing a circular area equal to an outer diameter of a locknut terminates in a lip. A plurality of teeth spaced at a predetermined distance engage lugs of a locknut. The teeth have sufficient height to engage the lugs when force is applied to the socket. A centering stem within the wall coacts with an inner wall of an electrical conduit opening to axially align the teeth with lugs of a locknut about the opening. A tapered lead in provides spatial relief for initial engagement of the stem with an inner wall of an opening. A well between the stem and the teeth provide a recess for protruding walls of an electrical conduit opening to reside in during engagement of the teeth with lugs of a locknut about the opening.

U.S. Pat. No. 7,156,000 to Lucien J. Wroblewski discloses an electrical conduit connector locknut wrench for use in connection with a locknut including outwardly extending protrusions. The wrench includes a base portion and a finger and an engagement tab extending from the base portion. The finger is spaced from the engagement portion with a recess provided between the finger and the engagement portion. To rotate the nut, the finger is positioned over the top surface of the nut. The engagement tab is angled downwardly relative to the finger to engage the outwardly extending lugs of the locknut.

A major problem in designing a wrench for electrical locknuts is that there is little standardization in the shape and configuration of the locknuts. Although the inside diameter of the locknut is, of course, standardized by the male fittings which it must threadably engage, the outside diameter varies among manufacturers, as does the number of lugs provided about the locknut's periphery. As if that were not enough, the size of lugs on a single locknut may not be uniform. These factors make it difficult to design a socket wrench which fits all locknuts of a particular inside diameter. There are at least half a dozen locknuts of different sizes and shapes for each nominal size. of Therefore, there is a need for an electrical locknut socket wrench which can be used to tighten or loosen all locknuts of a single nominal size, despite differences in lug configuration and size and the number of lugs present on the periphery of the locknut.

### SUMMARY OF THE INVENTION

The present invention provides a socket wrench for electrical locknuts that is highly tolerant of size differences of electrical locknuts of a nominal size and the number and spacing of lugs thereon. The socket wrench, in its most simple form, is machined from a single piece of metal, and includes a cylindrical wall that is unitary with a socket ceiling having a square drive aperture centered therein. A pair of diametrically-opposed semi-cylindrical vertical projections extend inwardly from the cylindrical wall. The vertical projections operate on a pair of diametrically-opposed lugs on the electrical locknut. The semi-cylindrical shape of the vertical projections causes the socket to self-center on an engaged locknut when the socket is turned in either clockwise or counterclockwise direction. Thus, a socket designed for a nominal size of electrical locknut is able to accommodate virtually any electrical locknut of that nominal size which incorporates multiple pairs of diametrically-opposed lugs. Although locknuts with uneven numbers of lugs are either extremely rare or nonexistent, it is likely that the socket could also successfully engage such a locknut.

In order to simplify and reduce the cost of manufacture, the electrical locknut socket wrench can be made of three pieces which are either assembled in a pressed fit, welded, or adhesively bonded together. A thickened cylindrical wall is used that is also unitary with a socket ceiling having a square drive aperture centered therein. An inner annular shoulder is cut in the thickened cylindrical wall, and diametrically-opposed holes are drilled parallel to the axis of the cylindrical wall. Cylindrical pins are then installed within the diametrically-opposed holes, so that semi-cylindrical vertical projections, extending from the shoulder to the bottom edge of the cylindrical wall, are formed. The cylindrical pins are either maintained in position by an interference fit, by welding, brazing or adhesive bonding.

For an alternative embodiment, the semi-cylindrical vertical projections are replaced by a pair of diametrically-opposed angular vertical projections, with the surface of each projection being formed by two intersecting planes. For a socket which is machined from a single piece of metal, the angular vertical projections are more easily machined.

### BRIEF DESCRIPTION OF THE DRAWINGS

FIG. 1 is a bottom plan view of a first embodiment of the new electrical locknut socket wrench;

FIG. 2 is a cross-sectional view of the first embodiment of the new electrical locknut socket wrench, taken through section line 2-2 of FIG. 1;

FIG. 3 is a cross-sectional view of the first embodiment of the new electrical locknut socket wrench, taken through section line 3-3 of FIG. 1;

FIG. 4 is a bottom plan view of the first embodiment of the new electrical locknut socket wrench and a first example electrical locknut positioned therewithin;

FIG. 5 is a bottom plan view of the first embodiment of the new electrical locknut socket wrench and a second example electrical locknut positioned therewithin;

FIG. 6 is a bottom plan view of the first embodiment of the new electrical locknut socket wrench and a third example electrical locknut positioned therewithin;

FIG. 7 is a bottom plan view of a second embodiment of the new electrical locknut socket wrench;

FIG. 8 is a cross-sectional view of the second embodiment of the new electrical locknut socket wrench, taken through section line 8-8 of FIG. 7;

FIG. 9 is a cross-sectional view of the first embodiment of the new electrical locknut socket wrench, taken through section line 9-9 of FIG. 7;

FIG. 10 is a bottom plan view of a third embodiment of the new electrical locknut socket wrench, which incorporates features of both the first and second embodiments;

FIG. 11 is a bottom plan view of a fourth embodiment of the new electrical locknut socket wrench; and

FIG. 12 is a side elevational view of any of the four embodiments of the new electrical locknut socket wrench, showing the knurling around the circumference of the upper (drive) end of the socket.

### PREFERRED EMBODIMENT OF THE INVENTION

The present invention provides a socket wrench for electrical locknuts that is highly tolerant of size differences of electrical locknuts of a nominal size and the number and spacing of lugs thereon.

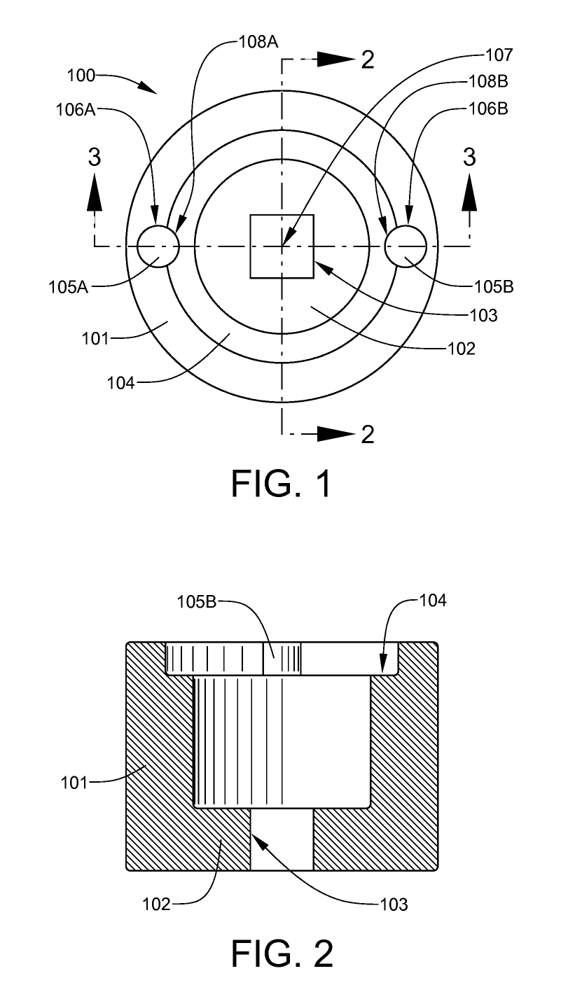

Referring now to FIG. 1, a first embodiment socket wrench 100 for electrical locknuts is seen in a bottom view. The first embodiment socket wrench 100 is assembled from three separate pieces which are joined together. A thickened cylindrical wall 101 is used that is also unitary with a socket ceiling 102 having a square drive aperture 103 centered therein. An inner annular shoulder 104 is cut in the thickened cylindrical wall 101, and identical cylindrical pins 105A and 105B are installed in diametrically-opposed holes 106A and 106B, respectively, which are drilled parallel to the axis 107 of the cylindrical wall 101. The cylindrical pins 105A and 105B are then installed within the diametrically-opposed holes 106A and 106B, respectively, so that semi-cylindrical vertical projections 108A and 108B, extending from the shoulder 104 to the bottom edge of the cylindrical wall, are formed. The cylindrical pins 105A and 105B are either maintained in position by an interference fit, by welding, brazing or adhesive bonding. The thickened cylindrical wall 101 and the cylindrical pins 105A and 105B are preferably made of a tough, wear-resistant metal or metal alloy, such as chrome-molybdenum steel, which may be hardened to increase resistance to wear.

Referring now to FIG. 2, this cross-sectional view of the first embodiment socket wrench 100, taken through section line 2-2 of FIG. 1, shows the thickened cylindrical wall 101, the socket ceiling 102, the square drive aperture 103, the inner annular shoulder 104 that is cut in the thickened cylindrical wall 101, and one of the semi-cylindrical vertical projections 108 formed by one of the cylindrical pins 105.

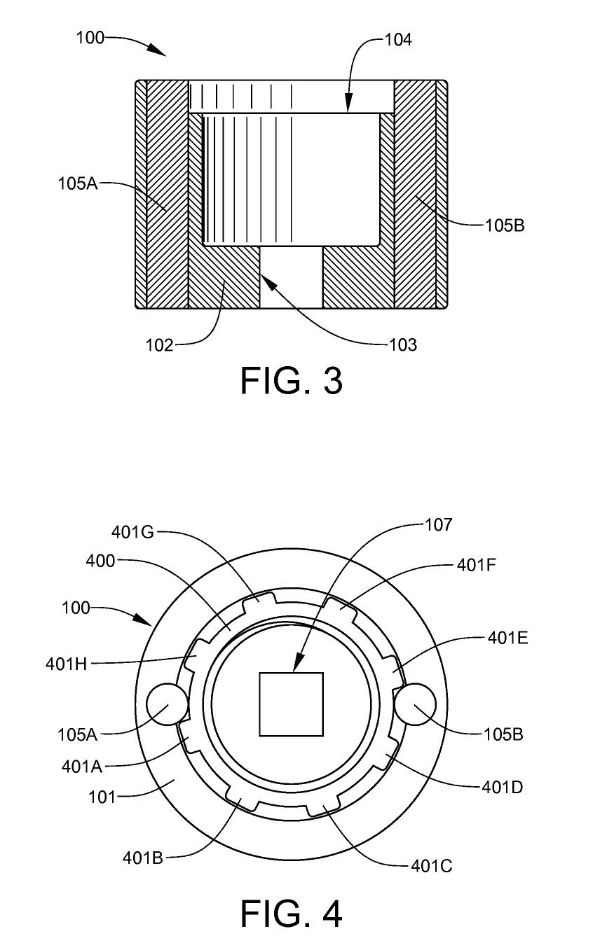

Referring now to FIG. 3, this cross-sectional view of the first embodiment socket wrench 100, taken through section line 3-3 of FIG. 1, shows the thickened cylindrical wall 101, the socket ceiling 102, the square drive aperture 103, the inner annular shoulder 104 that is cut in the thickened cylindrical wall 101, and both cylindrical pins 105A and 105B.

Referring now to FIG. 4, a first type of treaded electrical locknut 400 having eight equiangularly-spaced lugs 401A-401H is shown installed within the first embodiment electrical socket wrench 100. It will be noted that each of the semi-cylindrical vertical projections 108A and 108B contact a pair of diametrically-opposed lugs 401A and 401E. Because of the semi-cylindrical nature of the vertical projections 108A and 108B, the socket wrench tends to self center on the locknut 400. In addition, the inside diameter of the thickened cylindrical wall 101 can be sized to fit over a male threaded male stub end which the locknut 400 engages with very little clearance, thereby ensuring that the socket wrench 100 will be virtually centered on the electrical locknut 400.

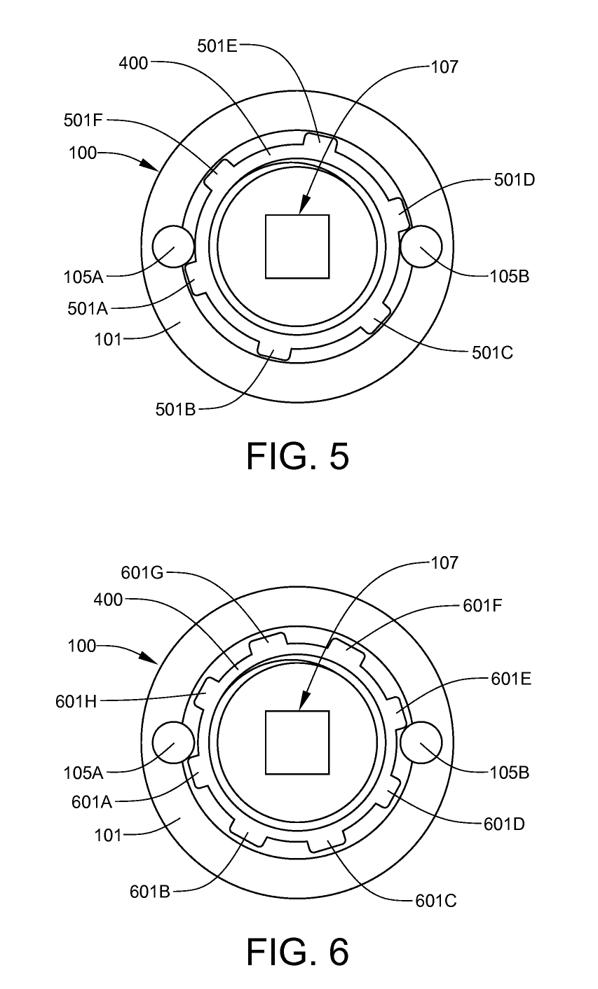

Referring now to FIG. 5, a second type of treaded electrical locknut 500 having only six equiangularly-spaced lugs 501A-501F is shown installed within the first embodiment electrical socket wrench 100. It will be noted that each of the semi-cylindrical vertical projections 108A and 108B contact a pair of diametrically-opposed lugs 501A and 401D. Because of the semi-cylindrical nature of the vertical projections 108A and 108B, the socket wrench tends to self center on the locknut 500.

Referring now to FIG. 6, a third type of treaded electrical locknut 600 having eight equiangularly-spaced lugs 601A-601H is shown installed within the first embodiment electrical socket wrench 100. It will be noted that although this third type of threaded electrical locknut 600 is smaller in diameter than the first and second electrical locknuts 400 and 500, respectively, each of the semi-cylindrical vertical projections 108A and 108B contact a pair of diametrically-opposed lugs 601A and 601E. Because of the semi-cylindrical nature of the vertical projections 108A and 108B, the socket wrench tends to self center on the locknut 600.

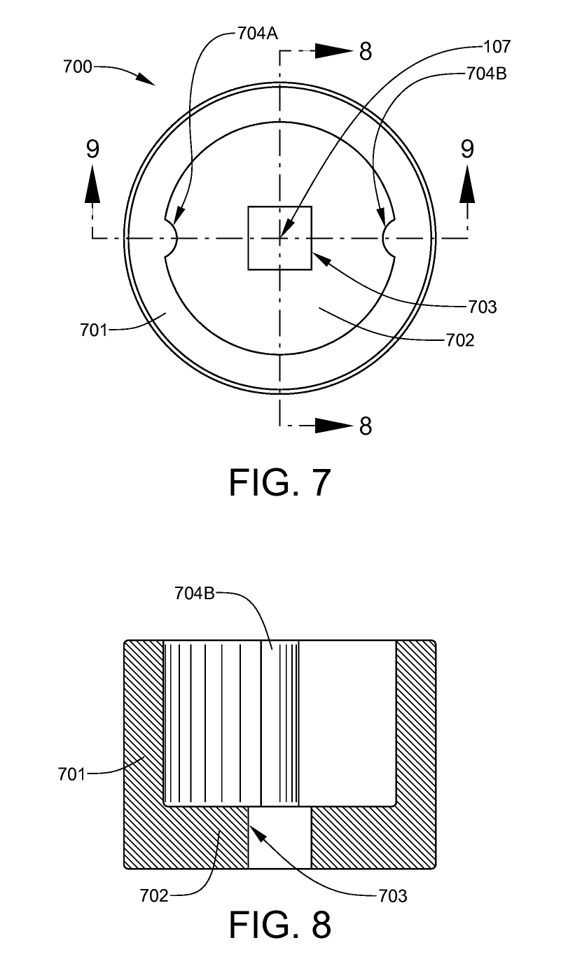

Referring now to FIG. 7, a second embodiment socket wrench 700 for electrical locknuts is seen in a bottom view. The second embodiment socket wrench 700 is machined from a single piece of tough, wear-resistant metal or metal alloy, such as chrome-molybdenum steel. It may be hardened subsequent to machining in order to increase its resistance to wear. The second embodiment socket wrench 700 does not have an inner annular shoulder 104, as does the first embodiment socket wrench 100. Rather, it has a thinner cylindrical wall 701 which extends from the bottom of the socket to the socket ceiling 702. The socket ceiling 702 is also equipped with a square drive aperture 703, which is centered therein. For the second embodiment socket wrench 700, the semi-cylindrical vertical projections 704A and 704B are unitary with the cylindrical wall 701. The first embodiment electrical locknut socket wrench 100 and the second embodiment electrical locknut socket wrench 700 are functionally equivalent.

Referring now to FIG. 8, this cross-sectional view of the first embodiment socket wrench 100, taken through section line 8-8 of FIG. 7, shows the cylindrical wall 701, the socket ceiling 702, and one semi-cylindrical vertical projection 704A.

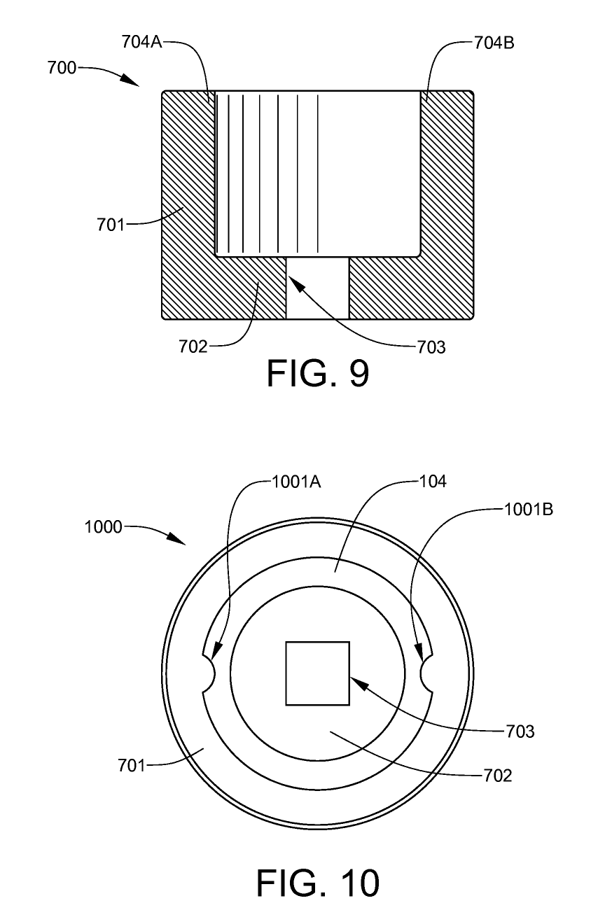

Referring now to FIG. 9, this cross-sectional view of the first embodiment socket wrench 100, taken through section line 9-9 of FIG. 7, shows the cylindrical wall 701, the socket ceiling 702, the square drive aperture 703, and both semi-cylindrical vertical projections ins 704A and 704B.

Referring now to FIG. 10, a bottom plan view of a third embodiment electrical locknut socket wrench 1000, which incorporates features both the unitary construction of the second embodiment electrical locknut socket wrench 700 and the inner annular shoulder 104 of the first embodiment electrical locknut socket wrench 100. For this third embodiment wrench 1000, the semi-cylindrical vertical projections 1001A and 1001B extend only to the inner annular shoulder 104.

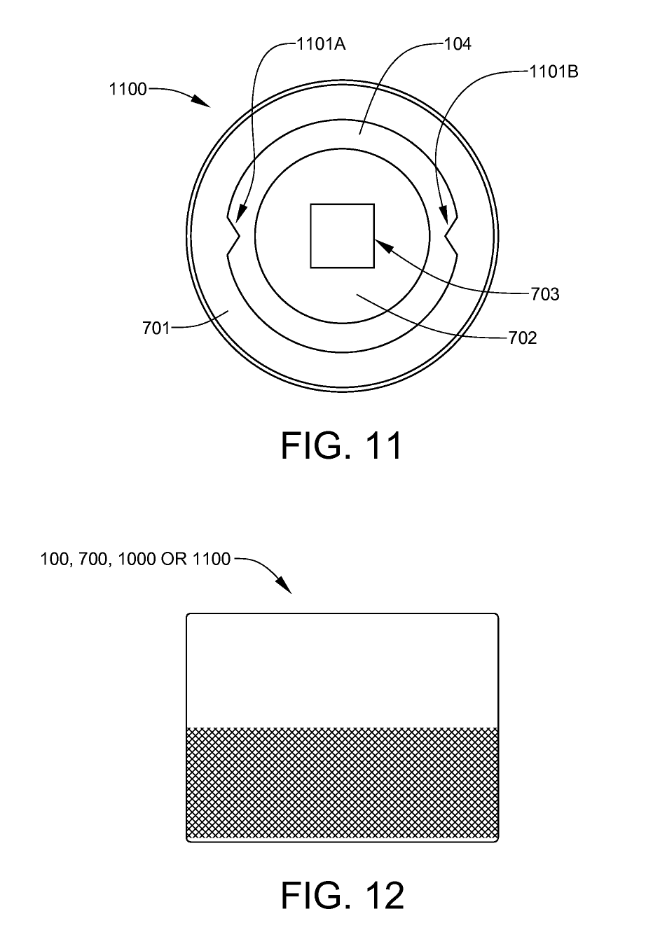

Referring now to FIG. 11 this bottom view of a fourth embodiment electrical locknut socket wrench 1100 is similar to the third embodiment electrical locknut socket wrench 1000, with the exception that the the semi-cylindrical vertical projections 1001A and 1001B are replaced by a pair of diametrically-opposed angular vertical projections 1101A and 1101B with the surface of each projection 1101A and 1101B being formed by two intersecting planes. For a socket which is machined from a single piece of metal, the angular vertical projections are more easily machined that semi-cylindrical projections.

Referring now to FIG. 12, this side view of any of the four embodiments of the new electrical locknut socket wrench 100, 700, 1000 or 1100 shows the knurling around the circumference of the upper (drive) end of the socket which enables a user to rotate any of them with his fingers.

Although only a single embodiment of the new socket wrench for electrical locknuts has been described herein, it should be obvious to those having ordinary skill in the art that changes and modifications may be made thereto without departing from the scope and the spirit of the invention as hereinafter claimed.

What is claimed is:

1. A socket wrench for electrical locknuts that is highly tolerant both of size differences between electrical locknuts of a nominal size, and which may have a varied number and spacing of lugs thereon, said socket comprising:
a generally cylindrical wall having a central axis
a ceiling continuous with said cylindrical wall at an upper end thereof;
means for driving the socket integrated with said ceiling and aligned with said central axis; and
a pair of diametrically-opposed semi-cylindrical vertical projections extending inwardly from the cylindrical wall, said vertical projections operable on a pair of diametrically-opposed lugs on the electrical locknut.

2. The socket wrench for electrical locknuts of claim 1, wherein the semi-cylindrical shape of the vertical projections causes the socket to self-center on an engaged locknut when the socket is turned in either clockwise or counterclockwise direction.

3. The socket wrench for electrical locknuts of claim 1, wherein said cylindrical wall, said ceiling, and said pair of diametrically-opposed semi-cylindrical vertical projections are unitary.

4. The socket wrench for electrical locknuts of claim 1, wherein said cylindrical wall has greater thickness near said ceiling, and said cylindrical wall and said ceiling are unitary, and said pair of diametrically-opposed semi-cylindrical vertical projections are formed by a pair of cylindrical pins which are installed in apertures within the cylindrical wall.

5. The socket wrench for electrical locknuts of claim 1, wherein said means for driving the socket is a square aperture cut in the ceiling.

6. The socket wrench for electrical locknuts of claim 4, wherein said cylindrical pins are heat treated for durability.

7. The socket wrench for electrical locknuts of claim
